(19) United States
(12) Patent Application Publication
(10) Pub. No.: US 2014/0078508 A1
(43) Pub. Date: Mar. 20, 2014

(54) OPTICAL MODULE

(71) Applicant: Fujitsu Optical Components Limited, Kawasaki-shi (JP)

(72) Inventor: Hirofumi AOTA, Oyama (JP)

(73) Assignee: Fujitsu Optical Components Limited, Kawasaki-shi (JP)

(21) Appl. No.: 14/085,273

(22) Filed: Nov. 20, 2013

Related U.S. Application Data
(63) Continuation of application No. PCT/JP2011/062031, filed on May 25, 2011.

(51) Int. Cl. G01B 9/02

(52) U.S. Cl. CPC G01B 9/02052
USPC 356/450

(57) ABSTRACT

An optical module includes an interferometer having at least two optical exit ends; an optoelectronic converting element having at least two light-receiving surfaces; and plural lenses that are disposed between the interferometer and the optoelectronic converting element, that optically couple light exiting from the interferometer with two light-receiving surfaces of the optoelectronic converting element. The lenses are disposed having focal distances and a distance therebetween that reduce positional displacement on the two light-receiving surfaces of the optoelectronic converting element, the positional displacement being generated at each of the two optical exit ends of the interferometer.

### CROSS REFERENCE TO RELATED APPLICATIONS

This application is a continuation application of International Application PCT/JP2011/062031, filed on May 25, 2011 and designating the U.S., the entire contents of which are incorporated herein by reference.

### FIELD

The embodiments discussed herein are related to an optical module that is used in an optical communication system.

### BACKGROUND

The communication capacity of optical communication systems has increased, and to cope with the increase, techniques for modulation and demodulation are used such as differential phase shift keying (DPSK) and differential quadrature phase shift keying (DQPSK). Compared to conventional methods such as the non return-to-zero (NRZ) method and the return-to-zero (RZ) method, DPSK and the DQPSK are advantageous when the transmission speed of data is high, and information is carried using optical signal phase variation.

An optical reception module will be described taking an example of an optical reception module that executes differential phase demodulation such as DPSK or DQPSK. The optical reception module mainly includes a pair of interferometers (a Mach-Zehnder interferometer) and a pair of optoelectronic converting elements. The interferometers have two exit ends. An optical signal input from an input fiber, etc., is transmitted through the interferometers and exits from the two exit ends. Based on the DPSK, the optical signals exiting from the two exit ends are optical signals whose phases are shifted by π from each other. The two exiting optical signals enter the two optoelectronic converting elements (hereinafter, referred to as “PDs”), are demodulated, and are converted into electronic signals (see, for example, Japanese Laid-Open Patent Publication Nos. 2010-145944, 2007-201939, and 2010-251439).

A planar light-wave circuit (PLC) is generally used for each of the interferometers used in the optical reception module. However, the PLC has a low tolerance to stress. If stress is present, distortion of the waveguides occurs and the polarization wavelength dependency changes. Consequently, a problem arises in that the optical property is degraded. Thus, when the PLC is fixed, to mitigate thermal stress generated between the PLC and a holding member, an adhesive having a low Young's modulus such as a silicone-based adhesive is often used therebetween. The thickness of the adhesive layer may be several 100 micrometers to fully mitigate the stress. As a result, when an optical reception module that uses a PLC is affected by vibration or variation of the environmental temperature, fluctuation of the PLC unit may increase and angular misalignment of the optical axis easily occurs.

In order for the PD used in the optical reception module for DPSK or DQPSK to handle high speed signals, the capacity has to be reduced. Accordingly, the light-receiving area of the light-receiving surface is small, and the diameter thereof is several 10 micrometers or less, and may even be about several micrometers depending on the case. Thus, if any angular misalignment or any position displacement occurs with respect to the optical signal exiting from the PLC, optical coupling of the PD therewith is difficult.

Based on the above, in the optical reception module, when the external environment varies, misalignment of the optical axis occurs in the PLC unit located on the exiting side of the optical signals. Furthermore, the light-receiving area of the PD located on the entrance side of the optical signal is small and therefore, it is difficult to optically couple the PD therewith. Thus, variation of the power of the optical signal entering the PD becomes significant and another problem arises in that light reception efficiency drops.

### SUMMARY

According to an aspect of an embodiment, an optical module includes an interferometer having at least two optical exit ends; an optoelectronic converting element having at least two light-receiving surfaces; and plural lenses that are disposed between the interferometer and the optoelectronic converting element, that optically couple light exiting from the interferometer with two light-receiving surfaces of the optoelectronic converting element. The lenses are disposed having focal distances and a distance therebetween that reduce positional displacement on the two light-receiving surfaces of the optoelectronic converting element, the positional displacement being generated at each of the two optical exit ends of the interferometer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a plan view of an optical module according to a first embodiment;

FIG. 2 is a side view of a state of optical axis misalignment of the optical module according to the first embodiment;

FIG. 3 is a side view of an example of a configuration of the optical module according to the first embodiment;

FIG. 4 is a side view of an example of a configuration of the optical module according to a second embodiment;

FIG. 5 is a side view of the state of the optical axis misalignment of the optical module according to the second embodiment;

FIG. 6 is a plan view of an example of a configuration of the optical module according to a third embodiment;

FIG. 7 is a side view the optical module according to the third embodiment;

FIG. 8 is a plan view of an example of a configuration of the optical module according to a fourth embodiment;

FIG. 9 is a side view of the optical module according to the fourth embodiment;

FIG. 10 is a plan view of an example of a configuration of the optical module according to a fifth embodiment;

FIG. 11 is a plan view of an example of a configuration of the optical module according to a sixth embodiment; and

FIG. 12 is a side view of the optical module according to the sixth embodiment.

### DESCRIPTION OF EMBODIMENTS

Embodiments of an optical module will be described in detail with reference to the accompanying drawings.

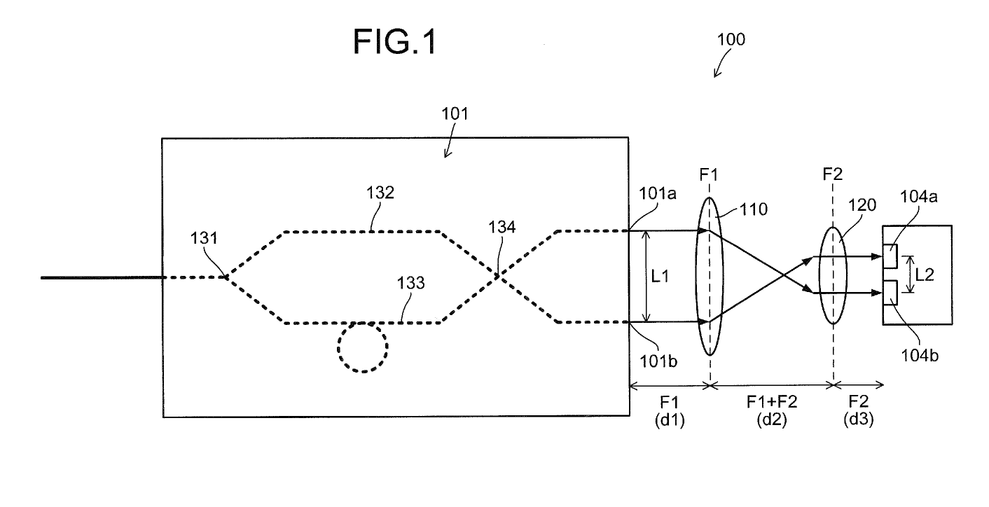

FIG. 1 is a plan view of an optical module according to a first embodiment. The optical module described below is an optical reception module that is used for a differential phase shift modulation signal of DPSK, the DQPSK, etc.

An optical reception module 100 includes a Mach-Zehnder PLC interferometer 101, a first lens 110, a second lens 120, and a pair of optoelectronic converting elements (PDs) 104a and 104b.

In the interferometer 101, an optical signal input from an input optical fiber, etc., is branched by a branching unit 131 and the resulting optical signals are output to the optical waveguides 132 and 133, respectively. The optical waveguides 132 and 133 respectively output to an interference unit 134, the optical signals that are from the branching unit 131. The optical waveguide 133 has a long waveguide length and a delay difference compared to the optical waveguide 132 and therefore, a delay difference is generated between the optical signals output to the interference unit 134.

The interference unit 134 causes the optical signals output from the optical waveguides 132 and 133 to interfere with each other and outputs optical signals acquired by the interference from two exit ends (output ports) 101a and 101b. Thereby, the phase-modulated optical signals input into the interference unit 134 are converted into intensity-modulated optical signals and are output.

The optical signals exiting from the exit ends 101a and 101b of the interferometer 101 are respectively coupled to the light-receiving surfaces of the PDs 104a and 104b by the two lenses (the first and the second lenses 110 and 120). In FIG. 1, only the central optical axes of the optical signals are depicted and the spread of each of the optical signals is not depicted. Denoting the focal distance of the first lens 110 on the side of the interferometer 101 as “F1”, that of the second lens 120 on the side of the PDs 104a and 104b as “F2”, the distance between the centers of the exit ends 101a and 101b of the interferometer 101 as “L1”, and the distance between the centers of the light-receiving surfaces of the two PDs 104a and 104b as “L2”, the optical module is configured to satisfy a condition

“L1>L2 and L1/L2=F1/F2”.

Denoting the distance from the exit ends 101a and 101b of the interferometer 101 to the principal surface of the first lens 110 as “d1”, the distance from the principal surface of the first lens 110 to the principal surface of the second lens 120 as “d2”, and the distance from the second lens 120 to the light-receiving surfaces of the optoelectronic converting elements (PDs) 104a and 104b as “d3”, the optical module is adapted to satisfy a condition “d1=F1”, “d2=F1+F2”, and “d3=F2”.

The pair of optoelectronic converting elements 104a and 104b balanced-receive the optical signals output from the interferometer 101, and each output a signal (electronic signal) acquired by the balanced reception.

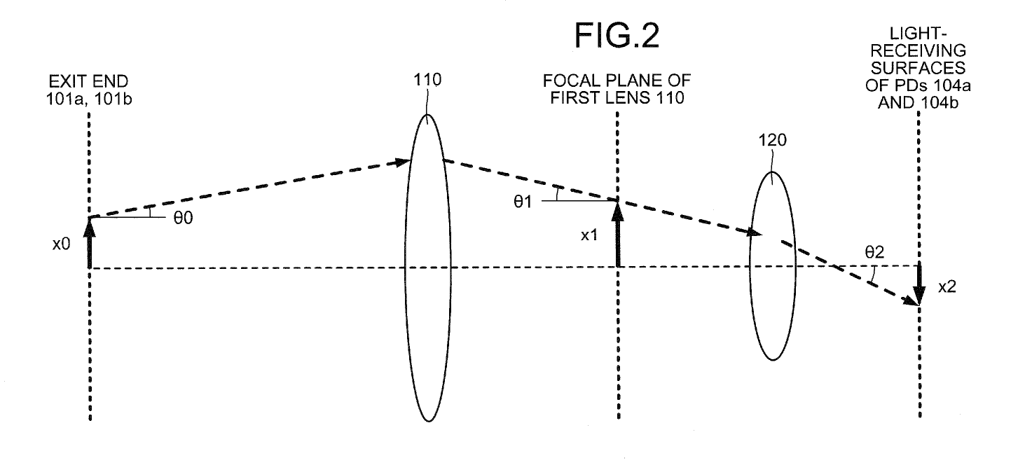

FIG. 2 is a side view of a state of optical axis misalignment of the optical module according to the first embodiment. It is assumed that, as depicted in FIG. 2, the optical signals exiting from the exit ends 101a and 101b of the interferometer 101 are, in an ideal state (an initial state), positioned to be transmitted at the centers of the two lenses (the first and the second lenses 110 and 120) and centers of the light-receiving surfaces of the PDs 104a and 104b.

Denoting a position displacement of each of the exit ends 101a and 101b from the central line as “x0” and angular misalignment thereof as “θ0” that are caused when a fluctuation occurs in the interferometer 101 due to the environmental variation, etc., and, assuming that a face away by the distance F1 in the direction of the second lens 120 from the principal surface of the first lens 110 is the focal plane of the first lens 110, a position displacement x1 and angular misalignment θ1 of the optical signal in the focal plane of the first lens 110 from the central line are expressed as below.

x1=F1×θ0 (1)

θ1=x0/f1 (2)

In Eqs. (1) to (4), for simplification of the description, the aberration and the astigmatism of each of the lenses are ignored; and it is assumed that θ0, θ1, and θ2 are minute amounts and sin(θ) is sin(θ)=θ. The same will be applied to the equations below.

Denoting position displacement from the central line on the light-receiving surface of each of the PDs 104a and 104b as “x2” and angular misalignment therefrom as “θ2”, equations as below are acquired.

x2=F2×θ1 (3)

θ2=x1/F2 (4)

Therefore, based on Eqs. (1), (2), (3), and (4), equations as below are acquired.

x2=F2/F1×x0 (5)

θ2=F1/F2×θ0 (6)

Because F2 and F1 are F2>F1: x2, that is, the position displacement of the optical signal from the light-receiving surface of each of the PDs 104a and 104b is compressed and reduced to F2/F1 times the position displacement x0 of the optical signal at each of the exiting ends 101a and 101b of the interferometer 101; and the angular misalignment θ2 is expanded and increased to F1/F2 times the angular misalignment θ0.

The area of the light-receiving surface of each of the PDs 104a and 104b used for the DPSK and the DQPSK is small. Therefore, for the light-receiving efficiency property, the PDs 104a and 104b are characterized in that the PDs 104a and 104b are vulnerable to position displacement while resistant against the angular misalignment compared to fiber coupling only when the optical signals enter the light-receiving surfaces. Even when the optical signal enters each of the light-receiving surfaces at an angle, each of the PDs 104a and 104b has a predetermined light-receiving sensitivity. As a result, fluctuation of the light-receiving efficiency can be suppressed even when the interferometer 101 is affected by environmental variations that cause fluctuations such as position displacement, angular misalignment, etc., occur in the optical signals exiting from the exit ends 101a and 101b. An optical module can be acquired that can maintain a stable light-receiving efficiency against environmental variations.

The optical signals from the two exit ends 101a and 101b of the interferometer 101 basically exit parallel to each other from the substrate end. Denoting that the interval between the exit ends 101a and 101b as “L1”, by assuming that the x0 of Eq. (5) is x0=L1, the interval L2 between the two optical signals on the light-receiving surfaces of the PDs 104a and 104b is acquired as below.

L2=F2/F1×l1 (7)

As described, by setting the distances to be L2/L1=F2/F1, the optical signals after transmission through the second lens 120, exit parallel to each other at an interval equal to that of the PDs 104a and 104b. Therefore, the adjustment during the manufacture can easily be executed and even when variation occurs along the optical axis of each of the PDs 104a and 104b, drops in the light-receiving efficiency are reduced.

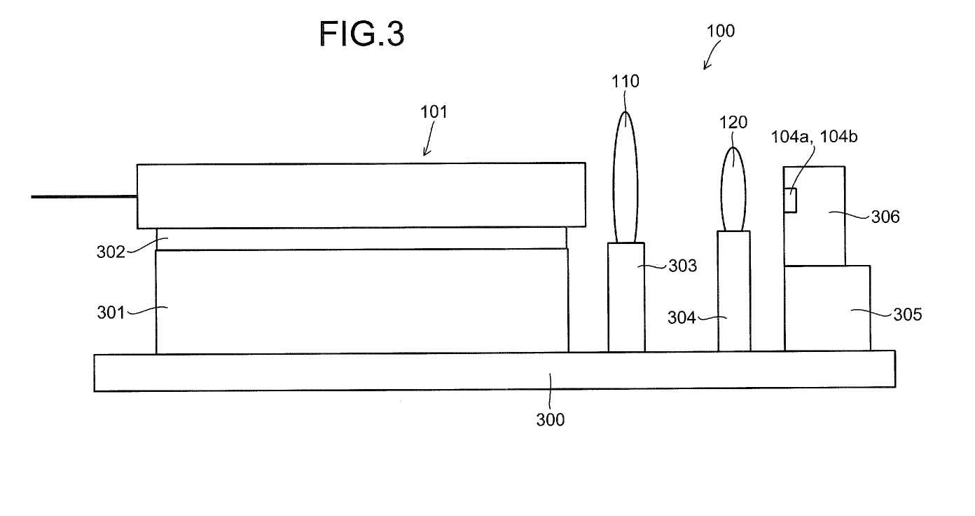

FIG. 3 is a side view of an example of a configuration of the optical module according to the first embodiment. A configuration, that is, an example of configuration is depicted where any one of the first and the second lenses 110 and 120, and the PDs 104a and 104b is not affected (does not fluctuate) even when fluctuations such as the position displacement and the angular misalignment of the interferometer 101 occur. In this configuration example, the interferometer 101 is structured not to fix the first and the second lenses 110 and 120, and the PDs 104a and 104b directly onto the interferometer 101 itself; or not to fix thereonto holding members that fix the first and the second lenses 110 and 120, and the PDs 104a and 104b.

Describing the example of configuration in FIG. 3, a holding member 301 is disposed on a base plate 300; and the interferometer 101 is disposed on the holding member 301 using an adhesive 302 having a low Young's modulus such as a silicone-based adhesive. Separately from the interferometer 101, the first lens 110 is disposed on the base plate 300 through the holding member 303. Similarly, the second lens 120 is disposed on the base plate 300 through a holding member 304. A PD unit 306 accommodating therein the PDs 104a and 104b is disposed on the base plate 300 through a holding member 305. The PD unit 306 retains the pair of PDs 104a and 104b.

Though not depicted, an example as a reference example will be described where the interferometer 101 is structured to fix the first and the second lenses 110 and 120 onto the interferometer 101. When the position displacement x0 and the angular misalignment θ0 occur in the interferometer 101, the position displacement x2 and the angular alignment θ2 of each of the PDs 104a and 104b are as below.

x2=x0+(2×F1+2×F2)×Tan(θ0) (8)

θ2=θ0 (9)

Although the angular misalignment does not increase, the position displacement increases, exceeding the original position displacement and therefore, no effect is acquired.

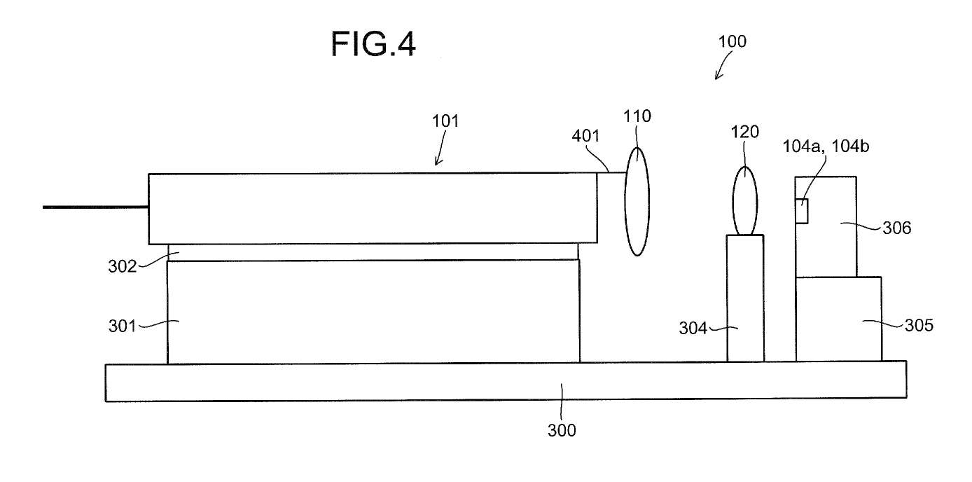

FIG. 4 is a side view of an example of a configuration of the optical module according to a second embodiment. The configuration example depicted in FIG. 4 is structured to fix the first lens 110 onto the interferometer 101 through a holding member 401. For example, a UV-curable adhesive for optical coupling including an acrylate resin or an epoxy resin can be used as the holding member 401. Other configurations are same as those of FIG. 3 and the second lens 120 is disposed on the base plate 300 through the holding member 304; and the PD unit 306 accommodating thereinto the PDs 104a and 104b is disposed on the base plate 300 through the holding member 305. Although a spherical lens is used as the first lens 110 in FIG. 4, a hemispherical lens can also be used. When a hemispherical lens is used as the first lens 110, a hemispherical lens may also be disposed oblique to the exit face of the interferometer 101 to prevent entrance into the interferometer, of the light beam reflected from the planar portion of the lens.

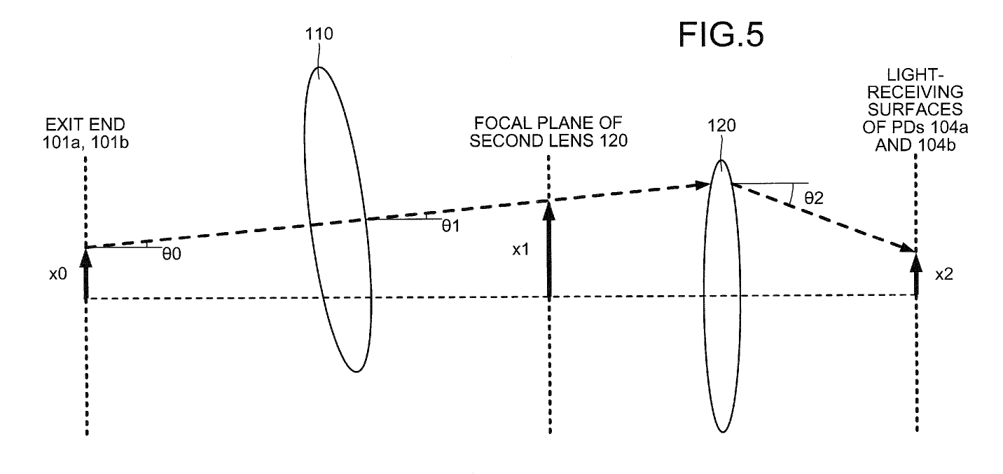

FIG. 5 is a side view of the state of the optical axis misalignment of the optical module according to the second embodiment. Assuming that the position displacement x0 and the angular misalignment θ0 occur in the interferometer 101 and that a plane away from the second lens 120 toward the first lens 110 by the distance F2 is a focal plane of the second lens 120, the position displacement x1 and the angular misalignment θ1 from the central line on this focal plane are acquired as below.

x1=x0+(2×F1)×Tan(θ0) (10)

θ1=θ0 (11)

Denoting the position displacement as “x2” and the angular misalignment “θ2” from the central line of each of the PD light-receiving surfaces 104a and 104b, equations are acquired as below.

x2=F2×θ0 (12)

θ2=[x0+(2×F1)×Tan(θ0)]/F2 (13)

The holding member 401 is fixed to the interferometer 101 and therefore, θ0 is minute. As a result, when x2 and x0 are x2<x0, an initial position displacement can be compressed. However, θ2 increases when θ0 takes any value. As a result, in this second embodiment, θ2 is increased while the angular misalignment on each of the light-receiving surfaces of the PDs 104a and 104b can be tolerated thereby, compared to those in the first embodiment. Therefore, the second embodiment is usable when, in the second embodiment, the focal distance F2 of the second lens 120 is selected such that a condition F2<x0/θ0 is satisfied for the initial angular misalignment θ0.

Effects will be described for the example of configurations of the embodiments using specific values. It is assumed that the position displacement x0 of the interferometer 101 is x0=10 micrometers, the angular misalignment θ0 thereof is θ0=0.1 degrees, the focal distance F1 of the first lens is F1=10 mm, and the focal distance F2 of the second lens 120 is F2=2 mm and that the focal distances F1 and F2, the distance between the interferometer 101 and the principal surface of the first lens 110, the distance between the principal surfaces of the first and the second lenses 110 and 120, and the distance between the principal surface of the second lens 120 and the light-receiving surfaces of the PDs 104a and 104b satisfy a condition that L1>L2 and 1/L2=F1/F2 and also satisfy a condition that d1=F1, d2=F1+F2, and d3=F2.

Based on these conditions, in the first embodiment, the position displacement x2 on each of the light-receiving surfaces of the PDs 104a and 104b is x2=2 micrometers and the angular misalignment θ2 thereon is θ2=0.5 degrees. In the second embodiment, the position displacement x2 is x2=3.5 micrometers and the angular misalignment θ2 is θ2=1.3 degrees. In the reference example, the position displacement x2 is x2=52 micrometers and the angular misalignment θ2 is θ2=0.1 degrees.

The tolerable amounts of x2 and θ2 for the light-receiving efficiency of the light-receiving surfaces of the PDs 104a and 104b differ depending on the performance of each of the PDs 104a and 104b. However, when x2 is within several micrometers and θ2 is within several degrees, x2 and θ2 are each often in respective tolerable ranges. Therefore, in the configurations of both of the first and the second embodiments, the position displacement and the angular misalignment can each be mitigated within the tolerable range. As opposed to this, in the reference example, the angular misalignment is mitigated within the tolerable range while the position displacement significantly departs from a tolerable range.

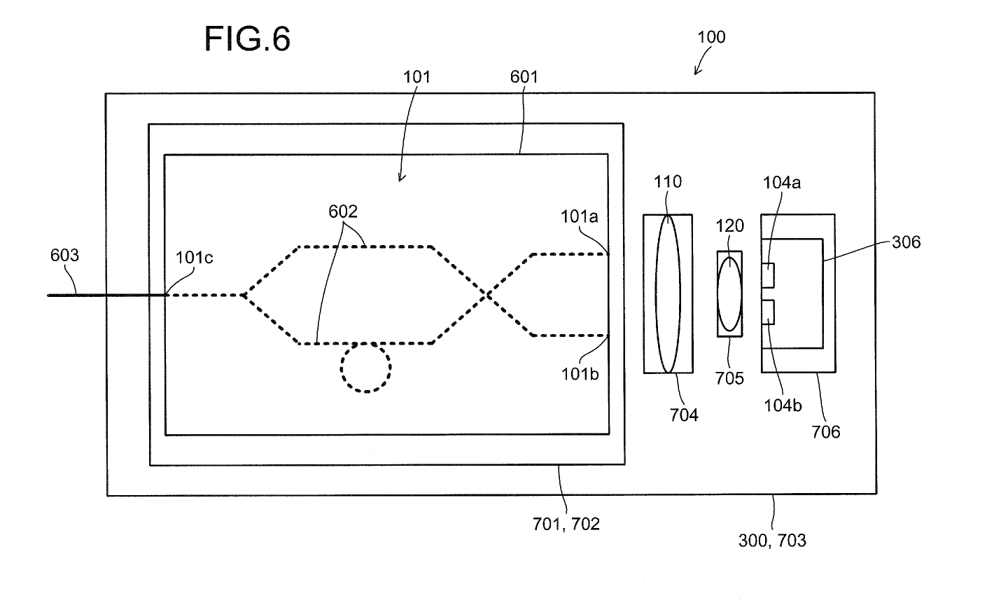

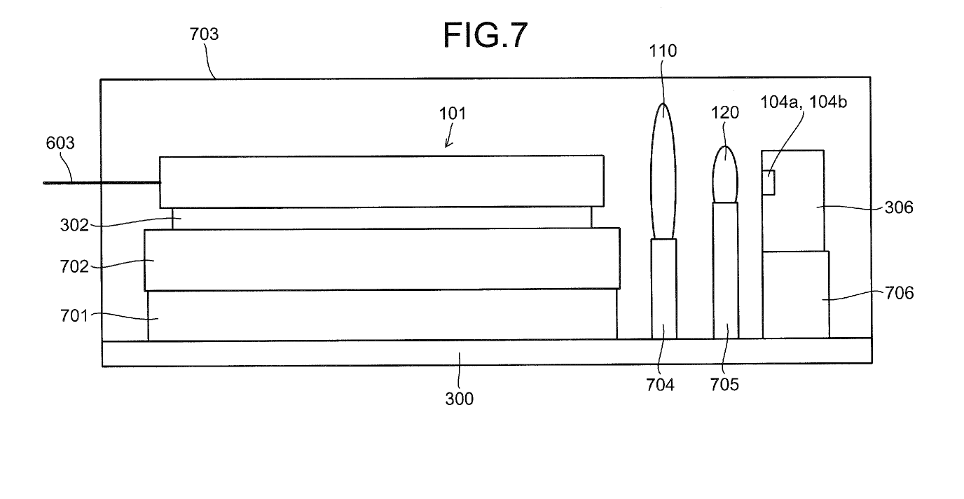

FIG. 6 is a plan view of an example of a configuration of the optical module according to a third embodiment. FIG. 7 is a side view thereof. FIGS. 6 and 7 depict an example of a configuration that employs the DPSK as a modulation method. The interferometer 101 is formed by, for example, forming optical waveguides 602 on a synthetic quartz glass substrate 601. The optical waveguides 602 are configured using, for example, quartz, lithium niobate (LN), or another semiconductor material.

For the DPSK, a pair of optical waveguides 602 branched in the interferometer 101 form a Mach-Zehnder interferometer, from which optical signals exit from the two exit ends 101a and 101b. To input an optical signal into the interferometer 101 from an external source, such configurations are present as a butt joint configuration to directly connect an input fiber 603 to an entrance end 101c of the interferometer 101 as depicted, and a configuration to emit once the light beam of the input fiber into the air and to couple the light beam with the entrance end 101c of the interferometer 101 through a lens.

As depicted in FIG. 7, the interferometer 101 controls the temperature to maintain a constant temperature using a thermal control element 701 such as a Peltier device or a heater to suppress any fluctuation of the wavelength. The thermal control element 701 is disposed on the base plate 300. To cause the temperature to be even in the interferometer 101: on the thermal control element 701, a thermal equalizing plate 702 is disposed that is formed by Cu or CuW having a high thermal conductivity; and the interferometer 101 is fixed on the thermal equalizing plate 702 using, for example, the adhesive 302 having a low Young's modulus such as a silicone-based adhesive. By using the silicone-based adhesive as the adhesive 302, stress generated between the thermal equalizing plate 702 and the interferometer 101 may be mitigated.

The PDs 104a and 104b are generally have low tolerance to humidity and therefore, a lid member 703 is disposed on the base plate 300, whereby internal airtight sealing is achieved. For example, kovar whose linear expansion coefficient is close to that of a ceramic used as an airtight sealing material is used as the material of a package that includes the base plate 300 and the lid member 703.

In the example of configuration of the third embodiment, as depicted in FIG. 7, on the base plate 300, a holding member 704 of the first lens 110, a holding member 705 of the second lens 120, and a holding member 706 of the PD unit 306 are disposed. Kovar, invar or super-invar having a small linear expansion coefficient, or quartz, etc., is used to match with the material of the package, as the material of the holding members 704, 705, and 706. The position of each of the holding members 704, 705, and 706 after the fixation can be adjusted by using YAG welding or a UV-curable adhesive. When no adjustment is necessary, a thermosetting adhesive can be used. The holding members 704, 705, and 706 may be formed to be integrated with the base plate 300, protruding therefrom.

For example, quartz glass, or ordinary glass such as BK7, SF11, or Pyrex (a registered trademark) taking into consideration the holding members can also be used as the material of the first and the second lenses 110 and 120. In addition, when one among or both of the first and the second lenses 110 and 120 is/are non-spherical lens(es), a glass material specific to a lens manufacturer can also be used. The UV-curable adhesive is used after the position adjustment for the fixation of the first and the second lenses 110 and 120 to the holding members 704 and 705.

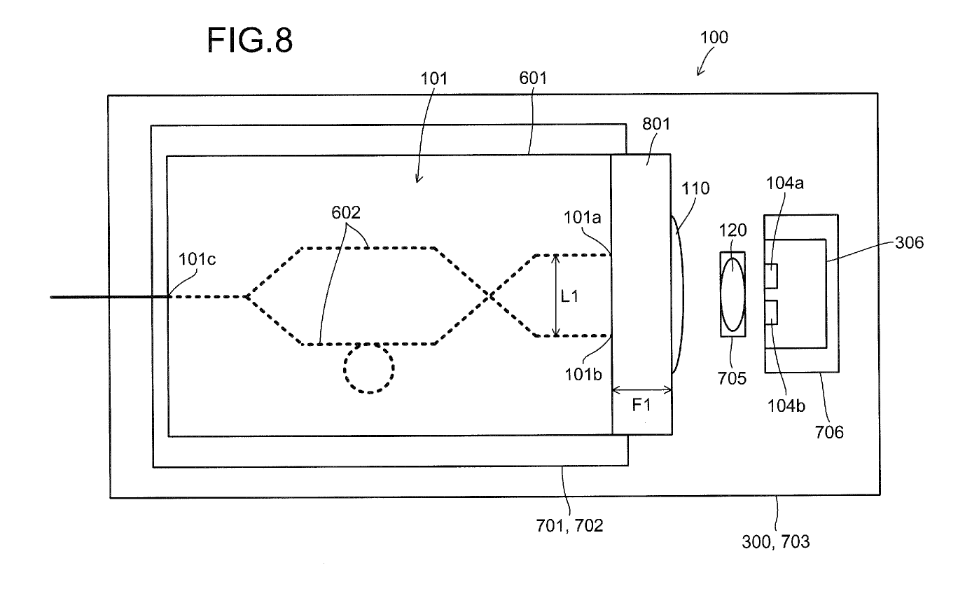

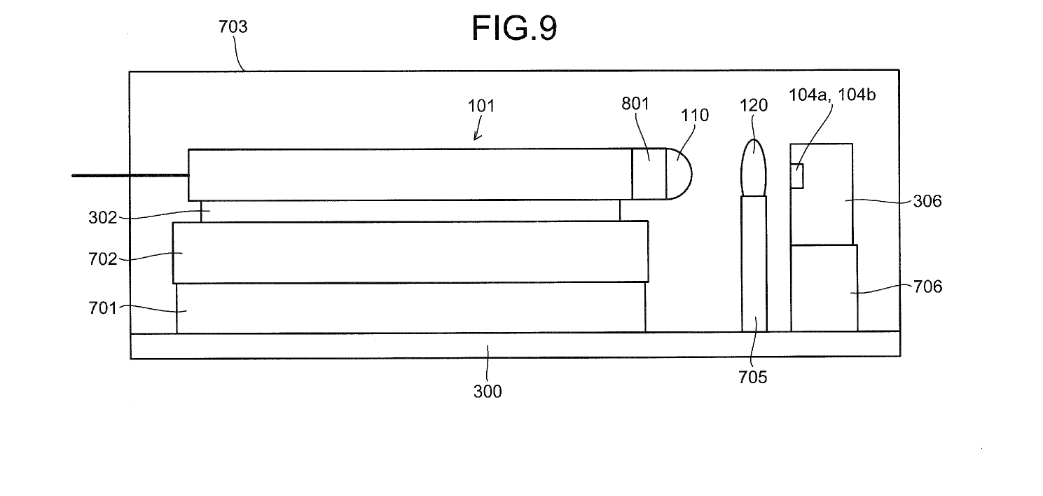

FIG. 8 is a plan view of an example of a configuration of the optical module according to a fourth embodiment. FIG. 9 is a side view thereof. FIGS. 8 and 9 depict the example of configuration that employs the DPSK as a modulation method. The fourth embodiment is configured to fix a spacer (holding member) 801 made from a transparent glass material to the portion of the exit ends 101a and 101b of the interferometer 101 and to fix the hemispherical first lens 110 to the spacer 801. The second lens 120 and the PD unit 306 are fixed using the holding members 705 and 706 similarly to the third embodiment.

As described, the configuration employing the spacer 801 is advantageous compared to the third embodiment in terms of space and manufacturability. Similarly to the first lens 110, etc., any one of quartz glass, BK7, SF11, Pyrex (a registered trademark), etc., is used as the glass material of the spacer 801. For the fixation of the spacer 801 and the first lens 110, a UV-curable adhesive for coupling optical paths is used whose refractive index matches with those of the above glass materials for an optical signal to be transmitted therethrough and whose transmission factor is high for the wavelength band of the optical signal.

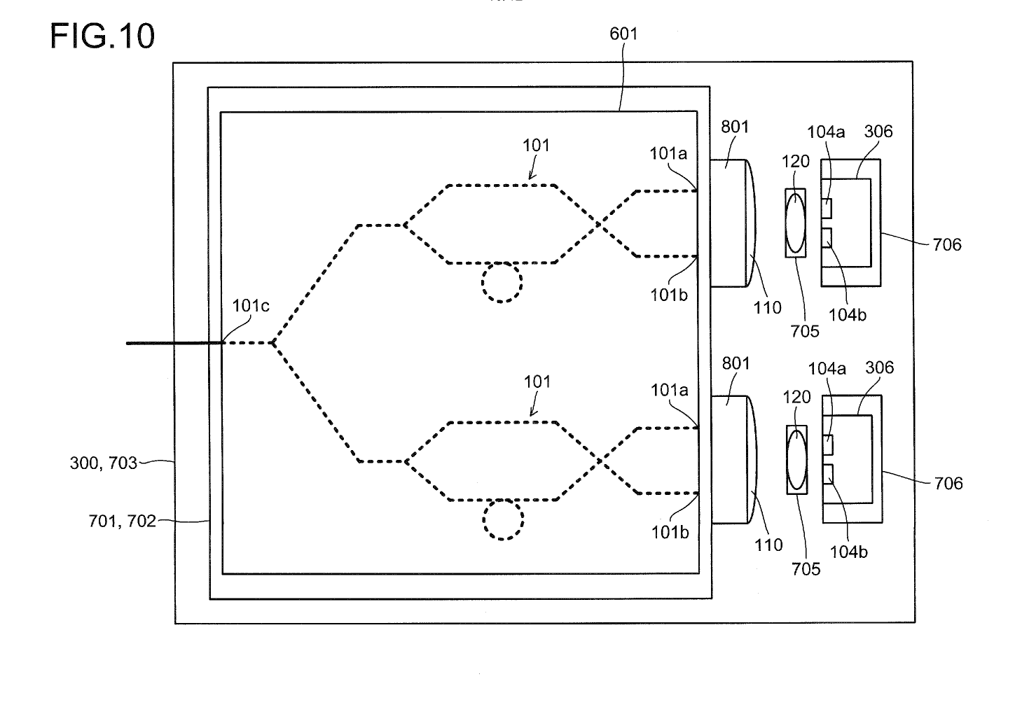

FIG. 10 is a plan view of an example of configuration of an optical module according to a fifth embodiment. The fifth embodiment is the example of configuration that employs the DQPSK as a modulation method using four phase shifts. Corresponding to this, two pairs of Mach-Zehnder interferometers 101 are used, each include exit ends 101a and 101b and therefore, includes four exit ends 101a, 101b, 101a, and 101b in total.

In the example of configuration for the DQPSK, for each of the interferometers 101, the configuration thereof is same as that for the DPSK. Therefore, two sets of the first and the second lenses 110 and 120, and the PD unit 306 are disposed. Similarly to the fourth embodiment, the example depicted in FIG. 10 is configured to fix the first lens 110 to the interferometer 101 by disposing the spacer 801. However, the example may be configured to fix the first lens 110 on the base plate 300 using the holding member 704, like the third embodiment.

In the embodiments, configurations have been described that each support the two phase shifts supporting the DPSK or the four phase shifts supporting the DQPSK. Assuming that “n” is a natural number, the optical module can be used as an optical module that handle 2n phase-shift modulation signals or an optical module that handle 2n phase-shift modulation signals each added with polarization information.

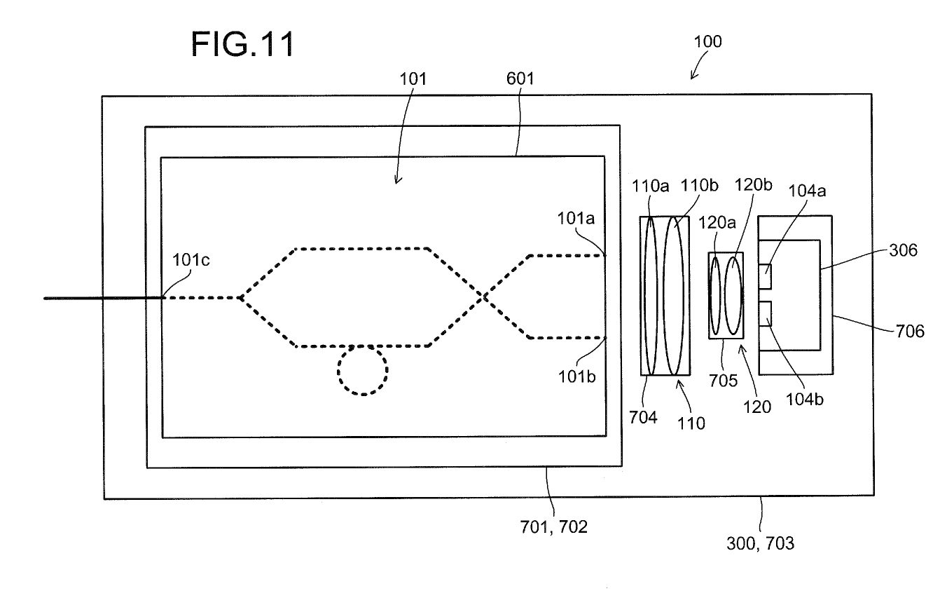

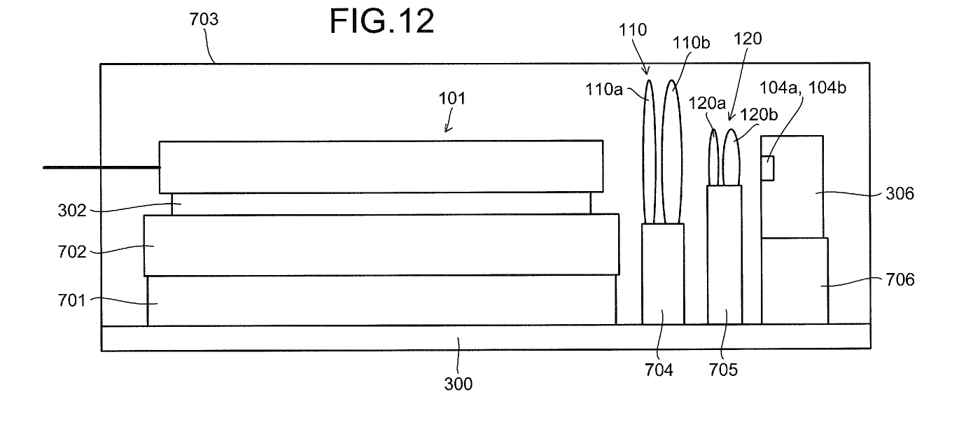

FIG. 11 is a plan view of an example of configuration of an optical module according to a sixth embodiment. FIG. 12 is a side view thereof. The configuration of the sixth embodiment is an example of a configuration that includes the first and the second lenses 110 and 120 that respectively are not a single lens described in the above embodiments but a lens group including plural lenses. In the depicted example, the first lens 110 is configured by two lenses 110a and 110b, and the second lens 120 is configured by two lenses 120a and 120b.

When each of the first and the second lenses 110 and 120 is configured by the plural lenses as above, by regarding the focal distances of the lens groups as the focal distances of the first and the second lenses 110 and 120, and the principal surfaces of the lens groups as the principal surfaces of the first and the second lenses 110 and 120, the same effect can be achieved as that of the case where the single lenses are used. The optical property of each of the lens groups can be improved when each of the lens groups is configured by plural lenses.

According to the embodiments, even when position displacement and angular misalignment occur in each optical axis of the optical signal exiting from the end face of the interferometer due to variation of the external environment such as vibration and the environmental temperature, the optical signal can be optically coupled with the optoelectronic converting element tolerating the gas and the misalignment, without any degradation of the light-receiving efficiency, and at high efficiency.

Thus, an optical module can be provided that can maintain the optical coupling efficiency using the interferometer such as the PLC that tends to be affected by variation of the external environment. This functional effect can easily be acquired by contriving the mutual arrangement of the first and the second lenses disposed between the interferometers and the optoelectronic converting element for the outputs of the one or more pairs of optical signals of the interferometers. Thereby, the optical signal can also be optically coupled at high efficiency with the PD that handles high speed signals and whose light-receiving area is small and therefore, a high-speed optical module can be acquired using a simple configuration.

According to the technique disclosed herein, an effect is achieved that, even when the external environment varies, fluctuation of the light-reception efficiency can be reduced and the light-reception efficiency of the optical coupling between the interferometer and the optoelectronic converting element can be increased.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical module comprising:
an interferometer having at least two optical exit ends;
an optoelectronic converting element having at least two light-receiving surfaces; and
a plurality of lenses that are disposed between the interferometer and the optoelectronic converting element, that optically couple light exiting from the interferometer with two light-receiving surfaces of the optoelectronic converting element, wherein
the lenses are disposed having focal distances and a distance therebetween that reduce positional displacement on the two light-receiving surfaces of the optoelectronic converting element, the positional displacement being generated at each of the two optical exit ends of the interferometer.

2. The optical module according to claim 1, wherein
the lenses comprise:
a first lens disposed adjacent to the interferometer, and
a second lens disposed adjacent to the optoelectronic converting element; and
a condition L1>L2 and L1/L2=F1/F2 is satisfied, where “L1” is an interval between the two optical exit ends of the interferometer, “L2” is an interval between the two light-receiving surfaces of the optoelectronic converting element, “F1” is a focal distance of the first lens, and “F2” is a focal distance of the second lens.

3. The optical module according to claim 2, wherein
a condition d1=f1, d2=F1+F2, and d3=F2 is satisfied, where “d1” is a distance from the two optical exit ends of the interferometer to a principal surface of the first lens as, “d2” is a distance from the principal surface of the first lens to a principal surface of the second lens, and “d3” is a distance from the principal surface of the second lens to the two light-receiving surfaces of the optoelectronic converting element.

4. The optical module according to claim 3, wherein
the second lens and the optoelectronic converting element are fixed to members that are not affected by the position displacement of each of the two optical exit ends of the interferometer.

5. The optical module according to claim 4, wherein
the second lens, the optoelectronic converting element, and the interferometer are disposed on holding members that are separately disposed from a base plate, and
the first lens is fixed adjacent to the two exit ends, by a holding member.

6. The optical module according to claim 3, wherein
the first lens, the second lens, and the optoelectronic converting element are fixed to members that are not affected by the position displacement of each of the two optical exit ends of the interferometer.

7. The optical module according to claim 6, wherein
the first lens, the second lens, the optoelectronic converting element, and the interferometer are disposed on holding members that are disposed separately from the base plate.

8. The optical module according to claim 3, wherein
the first and the second lenses each comprise a plurality of lenses.

9. The optical module according to claim 3, wherein
the interferometer comprises plural pairs of optical exit ends including two optical exit ends as one pair,
the optoelectronic converting element comprises plural pairs of light-receiving surfaces including two light-receiving surfaces as one pair, and
the first and the second lenses are disposed between the interferometer of each pair and the optoelectronic converting element.

10. The optical module according to claim 3, wherein
the interferometer is a planar light-wave circuit interferometer, and
temperature of the interferometer is controlled by a temperature control element.

11. The optical module according to claim 10, wherein
a thermal equalizing plate is disposed between the interferometer and the temperature control element.

12. The optical module according to claim 11, wherein
the interferometer is fixed onto the thermal equalizing plate by a silicone adhesive.
